(19) United States
(12) Patent Application Publication
(10) Pub. No.: US 2002/0122401 A1
(43) Pub. Date: Sep. 5, 2002

(54) System and method in a wireless telecommunication network for placing a voice call on hold and conducting a data session

(76) Inventors: Zeng-Jun Xiang, Palatine, IL (US); Akilan Tiburtius, Montreal (CA); Hanz Hager, Le Plessis Robinsson (FR)

Correspondence Address: ERICSSON RESEARCH CANADA, 8400 DECARIE BLVD., MONTREAL, QC, H4P 2N2, CA

(21) Appl. No.: 09/798,356

(22) Filed: Mar. 2, 2001

(51) Int. Cl. H04L 12/66

(52) U.S. Cl. 370/338; 370/352

(57) ABSTRACT

A system and method in a wireless telecommunication network for placing on hold an ongoing circuit-switched voice call between a first party and a second party, and conducting a packet-switched data session between the second party and a third party. An enhanced Gs interface between a Serving GPRS Support Node (SGSN) in a packet-switched network and a Mobile Switching Center (MSC) in a circuit-switched network enables messages to be passed that enable the second party to place the first party on hold and either accept an incoming data session from the third party or originate a data session to the third party. When the data session is completed, the MSC is notified, and the voice call is resumed between the first party and the second party.

### BACKGROUND OF THE INVENTION

1 . Technical Field of the Invention

This invention relates to telecommunication systems and, more particularly, to a system and method in a wireless telecommunication network for placing an ongoing circuit-switched voice call on hold and conducting a packet-switched data session.

2 . Description of Related Art

Wireless telecommunication networks are evolving from second generation (2G) circuit-switched networks to third generation (3G) packet-switched networks. A reference architecture for a 3G wireless network is being developed by the Third Generation Partnership Project (3GPP).

In today's Time Division Multiple Access (TDMA) systems, users can make real-time voice calls or send Short Message Service (SMS) messages through the existing circuit-switched infrastructure. In addition, users can conduct data transactions via a Cellular Digital Packet Data (CDPD)-based packet-switched system. In the next few years, high data rate 3G Enhanced Data rates for Global Evolution (EDGE) systems will be deployed in TDMA systems together with the introduction of Class B and Class C terminals. Class B terminals will support an automatic choice of services, both ANSI-136 voice and EDGE-based packet data, but only one at a time. Class C terminals will support packet data only.

Currently, there is a Gs interface between the ANSI-41/ANSI-136 circuit-switched domain and the EDGE-based packet-switched domain. Specifically, the Gs interface is between a Gateway Mobile Switching Center/Visitor Location Register (MSC/VLR) in a Circuit-Switched Core Network (CSCN) and a Serving GPRS Support Node (SGSN) in a General Packet Radio Service (GPRS) Packet-Switched Core Network (PSCN). The Gs interface is used to tunnel paging information from the MSC towards the SGSN for incoming circuit-switched voice calls, and to tunnel registration information from the SGSN towards the MSC.

If a mobile terminal is conducting a data session in the packet data mode, the user may interrupt the data session if notice of an incoming voice call is received. The SGSN sends a paging message to the user's mobile terminal indicating that there is an incoming circuit-switched voice call. The user can then put the data session on hold and answer the incoming voice call. The reverse, however, is not possible. If a user is in conversation with another user in the circuit-switched voice mode, and there is an incoming data session, the user cannot interrupt the voice call to conduct the data session. In other words, the multi-party capabilities of the system are set up so that a real-time voice call takes precedence over a non-real-time data session.

In order to overcome the disadvantage of existing solutions, it would be advantageous to have a system and method in a wireless telecommunication network for placing an ongoing circuit-switched voice call on hold to conduct a packet-switched data session. The present invention provides such a system and method.

### SUMMARY OF THE INVENTION

In one aspect, the present invention is a method in a wireless telecommunication network for placing on hold an ongoing circuit-switched voice call between a first party and a second party, and conducting a packet-switched data session between the second party and a third party. The method includes the steps of receiving in a packet-switched call-service node, a setup request for the data session; sending by the packet-switched node, the setup request for the data session to a circuit-switched call-service node that is handling the ongoing circuit-switched voice call; and upon receipt of the setup request, sending a call waiting indication for the data session from the circuit-switched node to the second party. In response to the call waiting indication, the second party sends an acceptance of the data session to the circuit-switched node. Upon receipt of the acceptance, the voice call is placed on hold by the circuit-switched node, and an acceptance of the data session is sent from the circuit-switched node to the packet-switched node. Upon receipt of the acceptance, the packet-switched node sets up and conducts the data session between the second party and the third party. Upon completion of the data session, a notification is sent from the packet-switched node to the circuit-switched node that the data session is completed. In response to the notification that the data session is completed, the circuit-switched node resumes the voice call between the first party and the second party.

In another aspect, the present invention is a system for interfacing a circuit-switched wireless telecommunication network with a packet-switched wireless telecommunication network. The system includes a packet-switched call-service node in the packet-switched network; a circuit-switched call-service node in the circuit-switched network; and an enhanced interface between the packet-switched call-service node and the circuit-switched call-service node. The enhanced interface provides multimedia-like services to a first, second, and third party by supporting a plurality of messages that perform the functions of (1) notifying the circuit-switched call-service node that the packet-switched call-service node has received a request from the third party to set up a data session with the second party when the second party is engaged in an ongoing circuit-switched voice call with a first party; (2) instructing the packet-switched call-service node to set up and conduct the packet data session between the second party and the third party after the circuit-switched call-service node has placed the first party on hold; and (3) notifying the circuit-switched call-service node when the data session is completed so that the circuit-switched call-service node can resume the voice call between the first party and the second party.

In yet another aspect, the present invention is a method in a wireless telecommunication network for placing on hold an ongoing circuit-switched voice call between a first party and a second party, and conducting a packet-switched data session between the second party and a third party. The method begins when the second party sends a notification to a circuit-switched call-service node that is handling the ongoing circuit-switched voice call that the second party is switching to the packet data mode. Upon receipt of the notification that the second party is switching to the packet data mode, the voice call is placed on hold by the circuit-switched node. The second party then sends a setup request for the data session to a packet-switched call-service node. The packet-switched node sends the setup request for the data session to the third party, and sets up and conducts the data session between the second party and the third party. Upon completion of the data session, a notification is sent from the packet-switched node to the circuit-switched node that the data session is completed. In response to the notification that the data session is completed, the circuit-switched node resumes the voice call between the first party and the second party.

In yet another aspect, the present invention is a system for interfacing a circuit-switched wireless telecommunication network with a packet-switched wireless telecommunication network. The system includes a packet-switched call-service node in the packet-switched network; a circuit-switched call-service node in the circuit-switched network; and an enhanced interface between the packet-switched call-service node and the circuit-switched call-service node. The enhanced interface provides multimedia-like services to a first, second, and third party by supporting a plurality of messages that perform the functions of (1) notifying the packet-switched call-service node that the voice call is on hold, after the second party notifies the circuit-switched call-service node that the second party is switching to a packet data mode, and the circuit-switched call service-node places the first party on hold; (2) requesting the packet-switched call-service node to set up and conduct the data session between the second party and the third party; and (3) notifying the circuit-switched call-service node when the data session is completed so that the circuit-switched call-service node can resume the voice call between the first party and the second party.

### BRIEF DESCRIPTION OF THE DRAWINGS

The invention will be better understood and its numerous objects and advantages will become more apparent to those skilled in the art by reference to the following drawings, in conjunction with the accompanying specification, in which:

FIG. 1 (Prior Art) is a simplified block diagram of a Circuit-Switched Core Network (CSCN), a Packet-Switched Core Network (PSCN), and the existing Gs interface;

FIG. 2 is a simplified block diagram of the CSCN, the PSCN, and the enhanced Gs interface of the present invention;

FIG. 3 is a signaling diagram illustrating the flow of messages between the CSCN and the PSCN in a first scenario when using the enhanced Gs interface to perform the method of the present invention; and

FIG. 4 is a signaling diagram illustrating the flow of messages between the CSCN and the PSCN in a second scenario when using the enhanced Gs interface to perform the method of the present invention.

### DETAILED DESCRIPTION OF EMBODIMENTS

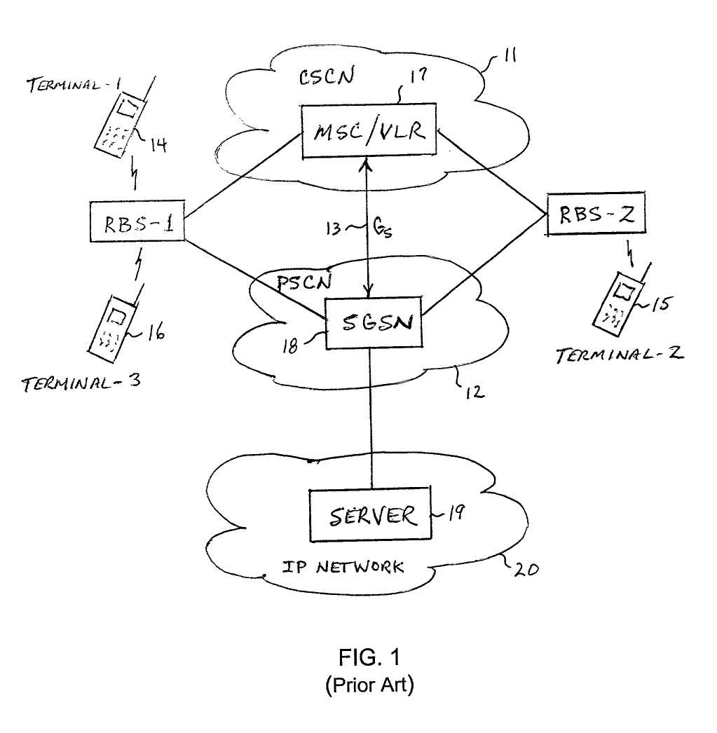

FIG. 1 is a simplified block diagram of a Circuit-Switched Core Network (CSCN) 11, a Packet-Switched Core Network (PSCN) 12, and the existing Gs interface 13. To illustrate the limitations of the existing Gs interface, assume that Terminal-1 14 is a IS-136 circuit-switched voice capable terminal only, Terminal-2 15 is a Class B mobile terminal, and Terminal-3 16 is either a Class B or a Class C mobile terminal. As noted above, in today's GPRS/EDGE specification, while Terminal-2 is in conversation with Terminal-3 in packet data mode, a voice call for Terminal-2 can be received in the MSC/VLR 17 from, for example, Terminal-1. The MSC/VLR sends a message across the Gs interface to the SGSN 18, and the SGSN informs the mobile terminal to switch from the packet data mode to the circuit-switched voice mode in order to receive the voice call from Terminal-1. Terminal-2 decides to answer the incoming circuit-switched voice call by putting the packet data session on hold.

However, the opposite scenario is not supported by the specified standards. For example, if Terminal-2 15 is in voice conversation in the circuit-switched voice mode with Terminal-1 14, and an incoming packet-switched data session initiated by Terminal-3 16 or a server 19 in an external IP network 20 is received in the SGSN 18, there are no provisions in the Gs interface specification for the SGSN to notify the MSC/VLR and Terminal-2 that there is an incoming packet-switched data session waiting.

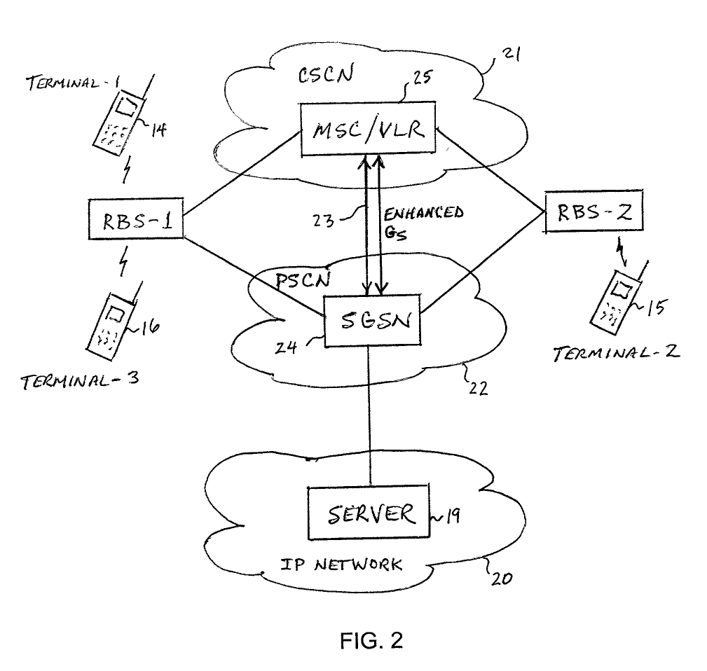

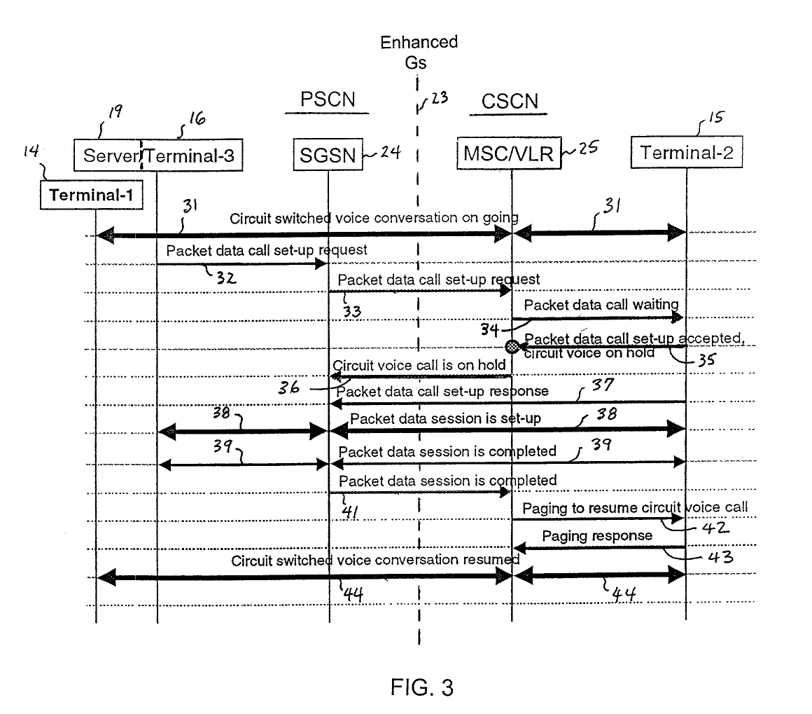

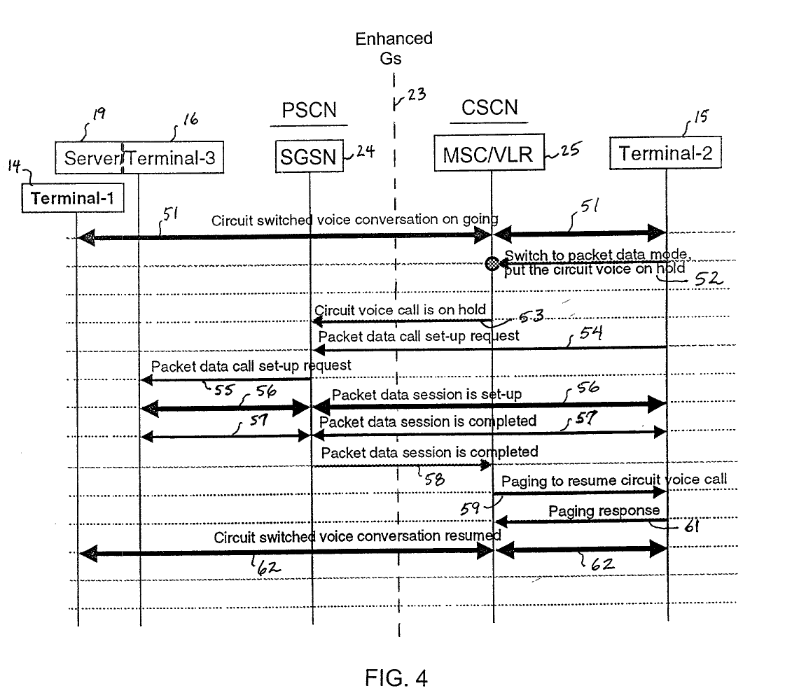

FIG. 2 is a simplified block diagram of a CSCN 21, a PSCN 22, and the enhanced Gs interface 23 of the present invention. The preferred embodiment of the present invention is described in terms of a GPRS/EDGE PSCN and a traditional second generation (2G) CSCN. Therefore, the packet-switched call-service node is referred to as an SGSN, and the circuit-switched call-service node is referred to as an MSC/VLR, although other call-service entities may be utilized. The Gs interface is enhanced in the present invention to carry additional messages which enable a mobile user to place a voice call on hold in order to accept and conduct an important incoming data session, and then resume the voice call when the data session is completed. In particular, additional messages are defined that are sent in the direction from the SGSN 24 to the MSC/VLR 25. The use of these messages is illustrated in two different scenarios in FIG. 3 and FIG. 4. Thus, the present invention takes the view, as an addition to existing standards, that some data sessions may be more important to the user than an ongoing voice call, and therefore, the user would like to interrupt the voice call and take the incoming data session. In addition, there may be situations in which the parties to a voice call need to acquire some information through a data session in order to continue their conversation. The present invention provides these capabilities.

FIG. 3 is a signaling diagram illustrating the flow of messages between the CSCN 21 and the PSCN 22 in a first scenario when using the enhanced Gs interface 23 to perform the method of the present invention. In the first scenario, Terminal-1 14 is a IS-136 circuit-switched voice capable terminal only, Terminal-2 15 is a Class B terminal, and Terminal-3 16 is either a Class B or a Class C terminal. In this scenario, Terminal-2 is notified of an incoming packet data message; Terminal-2 puts Terminal-1 on hold; Terminal-2 tunes to the packet data channel to conduct the packet data session; and Terminal-2 resumes the conversation with Terminal-1 after the data session is completed.

At step 31, Terminal-2 is in circuit-switched voice conversation with Terminal-1 when there is an important packet data message to be delivered to Terminal-2 from either the server 19 in the external IP network 20 or Terminal-3 16 via the GPRS/EDGE PSCN. At step 32, a Packet Data Call Setup Request message is received by the SGSN 24 in the PSCN. At step 33, the SGSN forwards the message across the enhanced Gs interface 23 to the gateway MSC/VLR 25 residing in the CSCN. The SGSN sends the message across the enhanced Gs interface in the opposite direction to what the standards now specify for setup messages.

At step 34, the MSC/VLR 25 inserts an incoming packet data waiting tone in the Digital Traffic Channel (DTC) towards Terminal-2 15 indicating that there is an important packet data session waiting for Terminal-2. The incoming packet data call waiting tone is preferably different from the incoming voice call waiting tone, and the importance level of the data session may be distinguished by using different tones.

Alternatively, a text message may be sent to Terminal-2 indicating that an incoming data session is waiting. The text message may additionally indicate the source of the data session since the Packet Data Call Setup Request message 33 has the source of the data session in it when it comes to the SGSN 24. This information can be passed to the MSC/VLR 25, and the MSC/VLR can put a short alphanumeric name for the source of the data session in the place of the normal calling line ID. The SGSN may also give the amount of data to be transferred during the data session and/or an estimated time period that the data session will take to transfer the data. The SGSN may then send this information to the MSC/VLR which forwards it to Terminal-2 in the text message. The MSC/VLR may additionally put the information in an announcement to Terminal-1, the user being put on hold. The information may also be used by the user of Terminal-2 to determine whether to put Terminal-1 on hold or to hang up and call him back if the session is estimated to be too long.

Once Terminal-2 detects the incoming packet data call waiting tone/message at 34, the user decides to answer the packet data session, and at step 35, Terminal-2 sends a new message to the MSC/VLR 25 indicating that packet data call setup is accepted. This action causes the MSC/VLR to put the circuit-switched voice call on hold. A single button is pushed on Terminal-2 to accept the packet data call and put the voice call on hold.

The MSC/VLR places the circuit-switched voice call between Terminal-1 and Terminal-2 on hold until further notice and sends a Circuit-Switched Voice Call on Hold message 36 to the SGSN 24. Terminal-2 then tunes to the packet data mode and sends a Packet Data Call Setup Response message 37 to the SGSN. The packet data session between Terminal-2 and either Terminal-3 16 or the server 19 in the external IP network 20 is then set up at 38.

Once the packet data session is completed at 39, the SGSN 24 sends a new Packet Data Session Completed message 41 to the MSC/VLR 25 via the enhanced Gs interface 23. Upon reception of the Packet Data Session Completed message, the MSC/VLR sends a paging message 42 to Terminal-2 to resume the circuit-switched voice call between Terminal-1 and Terminal-2. This is a new procedure designed to optimize the use of voice channels. If a voice call is put on hold, it is a waste of network resources to hold onto the voice channel while the call is on hold. The present invention preferably releases the voice channel when the voice call is put on hold. Therefore, the MT is re-paged in order to acquire another voice channel when the call is resumed.

This paging procedure is particularly useful when Class B terminals are in use. Class B terminals cannot be tuned to both the packet data mode and the circuit-switched voice mode at the same time. Thus, if the data session is accepted, the terminal is returned to the packet data channel. Therefore, even if the MSC held onto the voice channel, the terminal would still have to retune to the voice channel when the voice call is resumed. Therefore, the MSC releases the voice channel and then reacquires another voice channel when the voice call is resumed. As shown at step 43, Terminal-2 sends a page response to the MSC/VLR, and the circuit-switched voice call between Terminal-1 and Terminal-2 is then resumed at 44.

FIG. 4 is a signaling diagram illustrating the flow of messages between the CSCN 21 and the PSCN 22 in a second scenario when using the enhanced Gs interface 23 to perform the method of the present invention. Once again, Terminal-1 14 is a IS-136 circuit-switched voice capable terminal only, Terminal-2 15 is a Class B terminal, and Terminal-3 16 is either a Class B or a Class C terminal. In the second scenario, Terminal-1 and Terminal-2 are engaged in a circuit-switched voice call when Terminal-2 initiates a data session such as, for example, to check some important information that is needed to continue the conversation with Terminal-1. Terminal-2 may desire information either from the server 19 in the external IP network 20 or from Terminal-3 16. Rather than requiring Terminal-2 to hang up, perform the data session, and then call Terminal-1 again, the invention enables Terminal-2 to put the voice call on hold, initiate and conduct the data session, and then reconnect the voice call to Terminal-1. Thus, the invention gives the users the appearance of using a single multimedia network when there are actually two different networks.

At step 51, Terminal-2 is in circuit-switched voice conversation with Terminal-1. At 52, Terminal-2 sends a message of packet data acceptance and putting the voice call on hold to the MSC/VLR 25. One button is pushed on Terminal-2 to switch to the packet data mode and put the voice call on hold. The MSC/VLR places the circuit-switched voice call between Terminal-1 and Terminal-2 on hold until further notice, and sends a Circuit-Switched Voice Call on Hold message 53 to the SGSN 24 in the PSCN. Terminal-2 then tunes to the packet data mode and sends a Packet Data Call Setup Request message 54 to the SGSN. At 55, the SGSN forwards the Packet Data Call Setup Request message to the server 19 or Terminal-3, as appropriate. The packet data session between Terminal-2 and Terminal-3 or the server from the external IP network is then set up at 56.

Once the packet data session has been completed at 57, the SGSN 24 sends a Packet Data Session Completed message 58 to the MSC/VLR 25 via the enhanced Gs interface 23. Upon reception of the Packet Data Session Completed message, the MSC/VLR sends a paging message 59 to Terminal-2 to resume the circuit-switched voice call between Terminal-1 and Terminal-2. After Terminal-2 responds to the paging message at 61, the circuit-switched voice call between Terminal-1 and Terminal-2 is then resumed at 62.

It is thus believed that the operation and construction of the present invention will be apparent from the foregoing description. While the method, apparatus and system shown and described has been characterized as being preferred, it will be readily apparent that various changes and modifications could be made therein without departing from the scope of the invention as defined in the following claims.

What is claimed is:

1. A method in a wireless telecommunication network for placing on hold an ongoing circuit-switched voice call between a first party and a second party, and conducting a packet-switched data session between the second party and a third party, said method comprising the steps of:
sending by a packet-switched call-service node, a setup request for the data session to a circuit-switched call-service node that is handling the ongoing circuit-switched voice call;
upon receipt of the setup request, placing the voice call on hold by the circuit-switched node;
sending an acceptance of the data session from the circuit-switched node to the packet-switched node;
upon receipt of the acceptance, setting up the data session by the packet-switched node and conducting the data session between the second party and the third party;
upon completion of the data session, sending a notification from the packet-switched node to the circuit-switched node that the data session is completed; and
in response to the notification that the data session is completed, resuming by the circuit-switched node, the voice call between the first party and the second party.

2. The method of claim 1 further comprising, after the step of placing the voice call on hold, the step of sending an indication to the packet-switched node that the voice call is on hold.

3. The method of claim 1 wherein the step of placing the voice call on hold includes releasing by the circuit-switched node, a voice channel for the second party, and the step of resuming the voice call includes acquiring a second voice channel for the second party.

4. The method of claim 3 further comprising, after the step of sending a notification from the packet-switched node to the circuit-switched node that the data session is completed, the steps of:
paging the second party by the circuit-switched node;
sending a page response from the second party to the circuit-switched node; and
retuning the second party to the second voice channel.

5. The method of claim 1 further comprising, after the step of sending the setup request for the data session to the circuit-switched node, the steps of:
sending a call waiting indication for the data session from the circuit-switched node to the second party; and
in response to the call waiting indication, sending an acceptance of the data session from the second party to the circuit-switched node.

6. The method of claim 5 wherein the step of sending a call waiting indication for the data session to the second party includes sending a distinctive tone to the second party that is distinctly different from a call waiting indication for a voice call.

7. The method of claim 6 wherein the setup request for the data session includes an indication of a level of urgency assigned to the data session, and the step of sending a distinctive tone to the second party includes sending a tone that varies according to the level of urgency assigned to the data session.

8. The method of claim 5 wherein the step of sending a call waiting indication for the data session to the second party includes sending a text message to the second party indicating that a data session is waiting.

9. The method of claim 8 wherein the setup request for the data session includes an indication of a level of urgency assigned to the data session, and the step of sending a text message to the second party includes sending a text message that includes an indication of the level of urgency assigned to the data session.

10. The method of claim 8 wherein the setup request for the data session includes an indication of a source of the data session, and the step of sending a text message to the second party includes sending a text message that includes an indication of the source of the data session.

11. The method of claim 8 wherein the setup request for the data session includes an indication of an amount of data to be transferred in the data session, and the step of sending a text message to the second party includes sending a text message that includes an indication of the amount of data to be transferred in the data session.

12. The method of claim 11 wherein the step of sending a text message to the second party includes sending a text message that includes an indication of an estimated length of time required to conduct the data session.

13. The method of claim 12 further comprising, after the step of sending a text message to the second party that includes an indication of an estimated length of time required to conduct the data session, the step of sending an announcement from the circuit-switched node to the first party stating that the voice call is being put on hold, and providing the estimated length of time required to conduct the data session.

14. The method of claim 1 wherein the first, second, and third parties are mobile terminals in the wireless telecommunication network, and the method further comprises receiving in the packet-switched call-service node, a setup request for the data session from the third party.

15. The method of claim 1 wherein the first and second parties are mobile terminals in the wireless telecommunication network, and the third party is a server in an external Internet Protocol (IP) network, and the method further comprises receiving in the packet-switched call-service node, a setup request for the data session from the server.

16. A method in a wireless telecommunication network for placing on hold an ongoing circuit-switched voice call between a first party and a second party, and conducting a packet-switched data session between the second party and a third party, said method comprising the steps of:
sending a notification from the second party to a circuit-switched call-service node that is handling the ongoing circuit-switched voice call, said notification indicating that the second party is switching to a packet data mode;
upon receipt of the notification that the second party is switching to the packet data mode, placing the voice call on hold by the circuit-switched node;
sending a setup request for the data session from the second party to a packet-switched call-service node;
sending by the packet-switched node, the setup request for the data session to the third party;
setting up the data session by the packet-switched node and conducting the data session between the second party and the third party;
upon completion of the data session, sending a notification from the packet-switched node to the circuit-switched node that the data session is completed; and
in response to the notification that the data session is completed, resuming by the circuit-switched node, the voice call between the first party and the second party.

17. A system for interfacing a circuit-switched wireless telecommunication network with a packet-switched wireless telecommunication network, said system comprising:
a packet-switched call-service node in the packet-switched network;
a circuit-switched call-service node in the circuit-switched network; and
an enhanced interface between the packet-switched call-service node and the circuit-switched call-service node, said enhanced interface providing multimedia-like services to a first, second, and third party by supporting a plurality of messages that perform the functions of:
notifying the circuit-switched call-service node that the packet-switched call-service node has received a request from the third party to set up a data session with the second party when the second party is engaged in an ongoing circuit-switched voice call with the first party;
instructing the packet-switched call-service node to set up and conduct the packet data session between the second party and the third party after the circuit-switched call-service node has placed the first party on hold; and
notifying the circuit-switched call-service node when the data session is completed so that the circuit-switched call-service node can resume the voice call between the first party and the second party.

18. A system for interfacing a circuit-switched wireless telecommunication network with a packet-switched wireless telecommunication network, said system comprising:
a packet-switched call-service node in the packet-switched network;
a circuit-switched call-service node in the circuit-switched network; and
an enhanced interface between the packet-switched call-service node and the circuit-switched call-service node, said enhanced interface providing multimedia-like services to a first, second, and third party by supporting a plurality of messages that perform the functions of:
notifying the packet-switched call-service node that the voice call is on hold, after the second party notifies the circuit-switched call-service node that the second party is switching to a packet data mode, and the circuit-switched call-service node places the first party on hold;
requesting the packet-switched call-service node to set up and conduct the data session between the second party and the third party; and
notifying the circuit-switched call-service node when the data session is completed so that the circuit-switched call-service node can resume the voice call between the first party and the second party.
